(19) United States
(12) Patent Application Publication
(10) Pub. No.: US 2008/0198274 A1
(43) Pub. Date: Aug. 21, 2008

(54) Self-diagnosis and sequential-display method of every function

(76) Inventor: Sang Su Lee, Suweon-city (KR)

Correspondence Address: ROBERT E. BUSHNELL, 1522 K STREET NW, SUITE 300, WASHINGTON, DC, 20005-1202, US

(21) Appl. No.: 12/068,463

(22) Filed: Feb. 6, 2008

Related U.S. Application Data
(63) Continuation of application No. 07/631,240, filed on Dec. 20, 1990.

(30) Foreign Application Priority Data
Dec. 21, 1989 (KR) 89-19417

(51) Int. Cl. H04N 5/445

(52) U.S. Cl. 348/734; 348/177; 348/E05.099; 348/E05.096

(57) ABSTRACT

The present invention related to an automatic machine, which performs automatically self-diagnosis and demonstration of functions without individual manipulations of every function by informing the consumer operation states of selected functions after displaying sequentially menu screens with executing a subroutine stored in a microcomputer according to an entrance of a demonstration key.

### BACKGROUND OF THE INVENTION

The present invention relates to an automatic machine, and more particularly to a self-diagnosis and sequential-display method of every function of a system that each function is automatically controlled, being sequentially displayed, without individual manipulations.

As electric or electronic instruments become manifold, users must read the product manual or operate directly each function to understand various functions of a set by using set or remote controller keys. Therefore, there are many difficulties in the test of products under the manufacturing process since each function key must be individually manipulated. In an agency or a show room, also, the function keys are repeatedly pressed to explain a variety of functions to visitors or buyers.

### SUMMARY OF THE INVENTION

It is an object of the present invention to provide a self-diagnosis and sequential-display method of every function to explain automatically each function and to diagnose each mode by a single demonstration (DEMO) key.

According to present invention, in a system which displays the functions by using a microcomputer (MICOM) there is provided a self-diagnosis and sequential-display method, comprising: a first process for displaying sequentially menu screens of a set by recognizing a DEMO key, a second process for displaying a selection sequence of PICTURE, SOUND, and SOUND MULTIPLEX modes and for showing the change of pulse width modulation (PWM) value by executing a subroutine for a selected function after automatic selection of an arbitrary function, a third process for selecting and memorizing sequentially the channels on the air from the present channel by using AFT (Auto Fine Tuning) pulse after controlling the volume by executing the subroutine, a fourth process for executing RECALL ON/OFF, MUTE ON/OFF, VIDEO MODE CONTROL, SURROUND MODE CHANGE, COLOR CHANGE, and KOREAN/ENGLISH CHANGE functions, and a fifth process for displaying each mode again when the DEMO key is once again pressed.

### BRIEF DESCRIPTION OF THE DRAWINGS

These and other objects, features, and advantages of the present invention will become more apparent from the following description for the preferred embodiments taken in conjunction with the accompanying drawings, in which:

FIG. 1 is a circuit diagram around a microcomputer (MICOM) of the conventional television.

FIG. 2 is a flowchart for explaining a self-diagnosis and sequential-display method according to the present invention, and

FIG. 3 is a detailed flowchart of the subroutine in FIG. 2.

### DETAILED DESCRIPTION OF THE PREFERRED EMBODIMENT

The present invention will now be described in more detail with reference to the accompanying drawings.

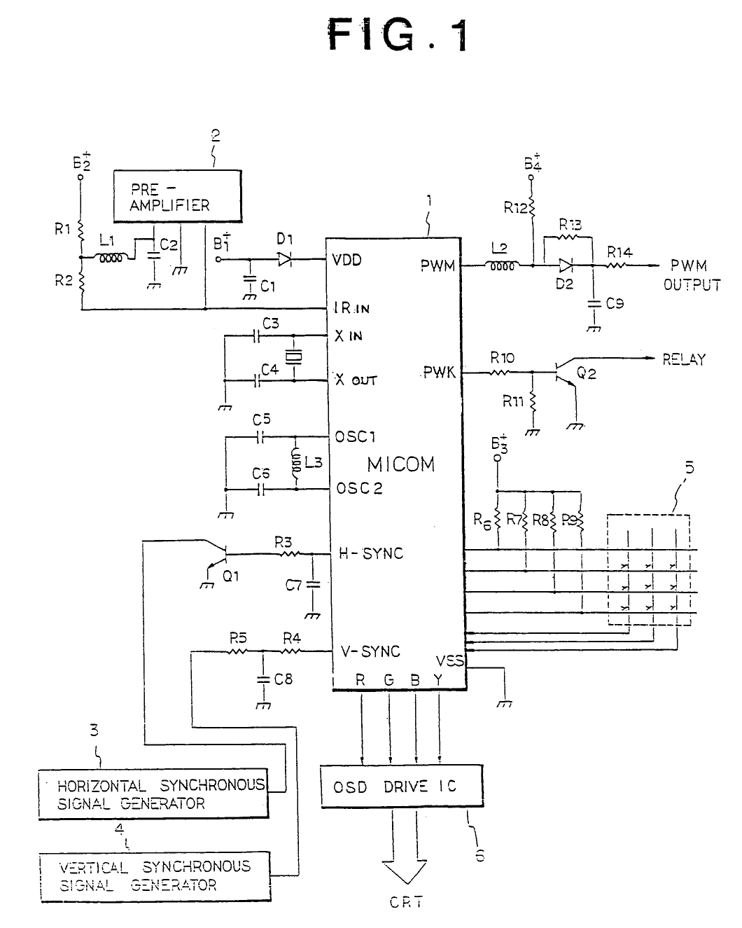

As an embodiment of the present invention, general functions which are applicable to a television are chosen and a circuit around a MICOM 1 inside the television is shown in FIG. 1. When a power VDD and a clock signal are applied to the MICOM 1, a transmitted signal from a remote controller is amplified by a pre-amplifier 2 and is subsequently applied to the MICOM 1.

Also, horizontal and vertical synchronous signals for on-screen display (OSD), which are respectively generated from horizontal and vertical synchronous signal generators 3 and 1, are applied to the MICOM 1. In addition, a key matrix 5 is connected to the MICOM 1 and thus the MICOM 1 recognizes the function key of MICOM 1 or the remote controller to display OSD characters on cathode ray tube (CRT) by driving an OSD drive integrated circuit (IC) 6.

The MICOM 1 turns on/off the main power by controlling the driving of a transistor Q2 and also controls the state of a set by controlling the PWM output signal. This structure is the same as the conventional state of a selected function on the CRT. In the present invention, the MICOM 1 recognizes the DEMO key through the key matrix 5 and pre-amplifier 2 and controls sequentially each function by controlling the character date and the PWM output signal which are provided to the OSD driver IC 6.

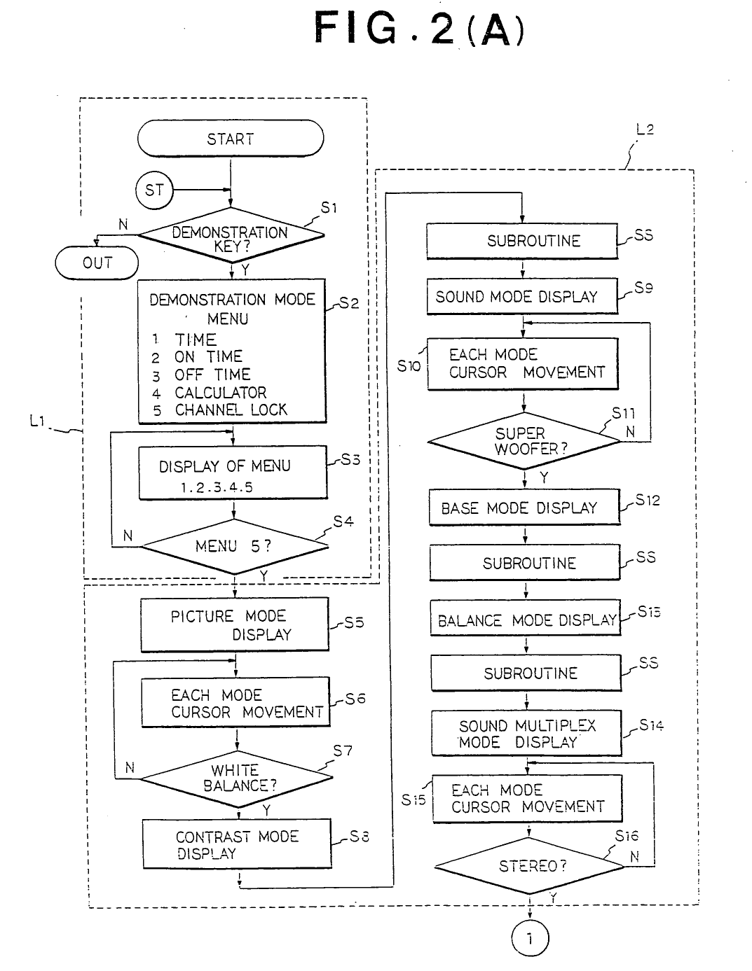

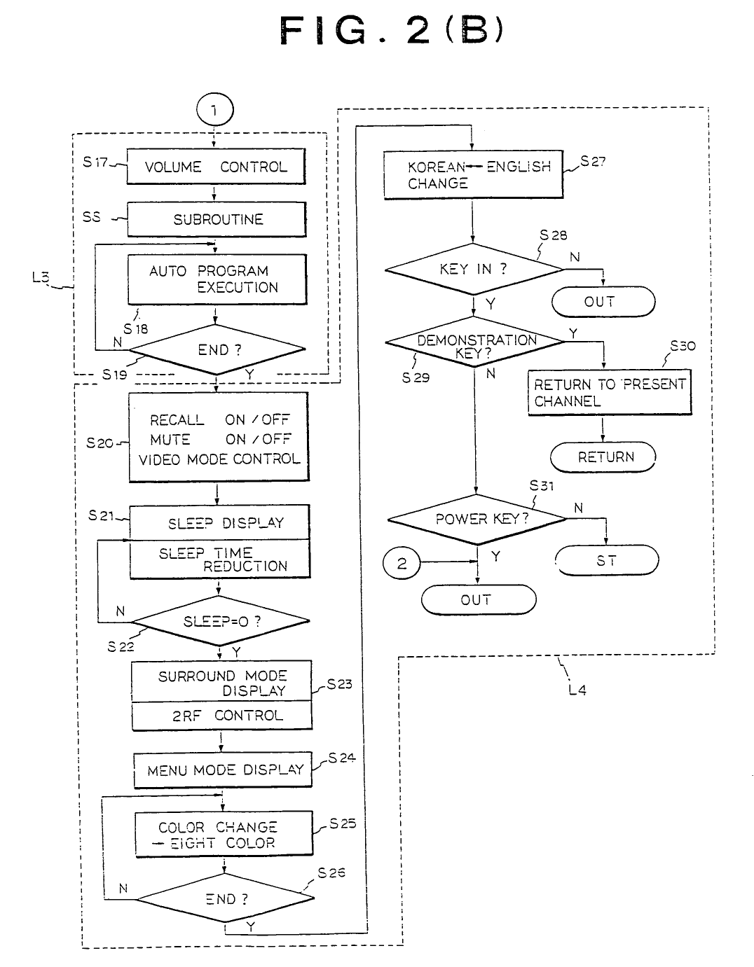

FIG. 2 shows a flowchart for the implementation of the self-diagnosis and sequential-display method according to the present invention.

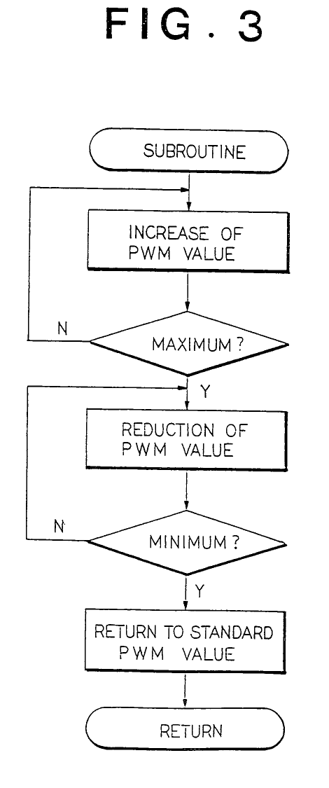

An entrance of the DEMO key is checked and the menu screens of a set are sequentially displayed in a first process 11. Next, the selection sequences of PICTURE, SOUND, and SOUND MULTIPLEX modes are displayed in a second process 12, and after the selection of an arbitrary function, this selected function is controlled by executing a subroutine in FIG. 3 and the change of PWM value is displayed. In a third process 13, a VOLUME CONTROL function is executed by the subroutine in FIG. 3 and an AUTO-PROGRAM which selects and memorizes sequentially channels on the air from the present channel is executed. In a fourth process 14, RECALL ON/OFF, MUTE ON/OFF, VIDEO MODE CONTROL, SURROUND MODE CHANGE, COLOR CHANGE, and KOREAN/ENGLISH CHANGE functions are sequentially executed. Finally, in a fifth process 15, if the DEMO key is pressed once again, every mode is sequentially displayed again, but if a power key is pressed, the system is turned off.

The operation of the present invention will be described in detail as follows.

In a step S1, it is distinguished that an input key is either the DEMO key or not. If the input key is proved as the DEMO key, a menu screen where the various functions such as 1. TIME, 2. ON TIME, 3. OFF TIME, 4. CALCULATOR and 5. CHANNEL-LOCK are listed is displayed in a step S2. Here, only five functions are listed as menu items, but there are, in fact, many functions.

In a step S3, the corresponding modes to the items listed on the menu screen are sequentially displayed. For example, in the TIME function, the present time set mode is displayed and similarly in the ON TIME or OFF TIME function, the ON TIME or OFF TIME memory mode is displayed. If it is proved in a step S4 that the menu modes were all displayed, the picture mode begins in a step S5. In the PICTURE mode, CONTRAST, BRIGHT, SHARPNESS, TINT, and WHITE BALANCE are controlled. At this time, the above menu items are displayed so that each item can be selected by moving a cursor in a step S6. In other words, if the PICTURE mode is selected by the step S5, the method of selecting the desired item by moving the cursor on the screen is shown by the step S6.

If it is distinguished that the cursor was moved from the first item CONTRAST, to the last item, WHITE BALANCE, in a step S7, the first item CONTRAST is automatically selected and displayed in a step S8 to explain an example. Then, a subroutine SS in FIG. 3 is executed to show an controlling method of a contrast function. In the subroutine SS, the PWM value of the CONTRAST mode is increased to a maximum value, and the PWM value is reduced again to a minimum value, and subsequently the CONTRAST is stabilized by setting a standard PWM value.

Next, the program returns from the subroutine to the main program. Thus, the user can see that each item in the PICTURE mode is selected by using a cursor and that the CONTRAST is adjusted from a maximum to a minimum value by the subroutine SS. After the PICTURE mode, the SOUND mode begins in a step S9. In the SOUND mode, BASS, TREBLE, BALANCE, SURROUND, and SUPER WOOFER are adjusted. Similar to the picture mode, it is shown in a step S10 that each item in the sound mode can be selected by moving the cursor.

If it is distinguished that the cursor was moved from the first item, BASS, to the last item, SUPER WOOFER, in a step S11, BASS mode is displayed to explain an example in a step S12. Then, the subroutine SS in FIG. 3 is again executed to show the controlling method of base function as described in the CONTRAST case of the PICTURE mode. In the subroutine SS, the PWM value for BASS mode is increased to a maximum value and the PWM value is again reduced to a minimum value, and subsequently, BASS is stabilized by setting a standard PWM value.

Next, the program returns from the subroutine SS to the main program. In other words, the user can see that each item in the SOUND mode is selected by using a cursor and that the BASS is adjusted from a maximum to a minimum value by the subroutine SS. Since the SOUND mode has sensitive influences on consumers, the BALANCE function is selected in a step S13 and is executed by the subroutine SS similar to the BASS function. Thus, the user can watch the operation states of BASS and BALANCE functions.

After the SOUND mode, the SOUND MULTIPLEX mode is displayed in a step S14. In the SOUND MULTIPLEX mode, VERNACULAR, FOREIGN LANGUAGE, VERNACULAR+FOREIGN LANGUAGE, and STEREO are adjusted. Similarly, the SOUND MULTIPLEX mode is shown by moving the cursor in a step S16, VOLUME CONTROL is displayed in a step S17 and is executed by the subroutine SS. That is, if the VOLUME CONTROL is selected, the PWM value for VOLUME CONTROL is increased to a maximum value and is again reduced to a minimum value, and subsequently the VOLUME is stabilized by setting a standard PWM value by the subroutine SS.

Next, the program enters the AUTO-PROGRAM mode in a step S18. In the AUTO-PROGRAM mode, it is shown that the channels on the air are sequentially selected from the present channel by using the well-known AFT pulse and are memorized. After the AUTO-PROGRAM mode is finished by a step S19, RECALL ON/OFF, MUTE ON/OFF, and VIDEO MODE CONTROL functions are executed in a step S20.

After the step S20, sleep function is displayed and the sleep time is one by one reduced to zero in a step 21. At this time, if the assigned SLEEP time arrives the main power of a set is turn off in a step S22. For example, if the SLEEP TIME is set to 20 minutes, the main power is turned off after 20 minutes.

After showing the SLEEP function, the SURROUND mode is displayed and MONO, HALL, STADIUM function in the SURROUND mode are sequentially displayed by executing 2RF control function in a step S23.

After the SURROUND mode, the menu screen is displayed again, being changed with eight colors, in a step S25. That is, the color of the menu screen is changed in turns by eight colors and after these colors change operation of the menu screen the KOREAN/ENGLISH CHANGE mode is executed to show the menu item in Korean and English in turns in a step S27.

After this KOREAN/ENGLISH CHANGE mode, the key input is checked in a step S28. So, if the DEMO key is pressed in a step 29, the channel returns to the previous channel under receiving in a step S30, where as if the power key is pressed the system is turned off in a step S31.

In the step S31, it is proved that the DEMO key is again pressed, the program returns to the beginning of the program, that is START mode to repeat the above operation from the first. Thus, the consumers can understand all of the functions in the set by using a DEMO key since the operation state of every function is sequentially displayed and controlled. Also, the function of a set is easily explained in the agency or show room.

As mentioned above, the present invention can be useful in the manufacturing line, the agent and show room because every function is displayed and controlled automatically and sequentially.

The invention is in no way limited to the embodiment described hereinabove. Various modifications of disclosed embodiment as well as other embodiments of the invention will become apparent to persons skilled in the art upon reference to the description of the invention. It is therefore contemplated that the appended claims will cover any such modifications or embodiments as fall within the true scope of the invention.

What is claimed is:

1. In a system which displays the functions on a screen by using a microcomputer, a self-diagnosis and sequential-display method comprising:
a first process for displaying sequentially menu screens of a set by recognizing a demonstration key,
a second process for displaying a selection sequence of PICTURE, SOUND and SOUND MULTIPLEX modes and for showing the change of pulse width modulation (PWM) value by executing a subroutine for a selected function after automatic selection of an arbitrary function,
a third process for selecting and memorizing sequentially channels on the air from the present channel by using the auto fine tuning (Fr) pulse after controlling the volume by executing said subroutine,
a fourth process for executing RECALL ON/OFF, MUTE ON/OFF, VIDEO MODE CONTROL, SURROUND MODE CHANGE, COLOR CHANGE, and KOREAN/ENGLISH CHANGE functions, and
a fifth process for displaying each mode again when the demonstration key is pressed once again.

2. A method according to claim 1, wherein said subroutine, first, increases the PWM value for each selected function to a maximum value and second reduces the PWM value to a minimum value again and third sets the PWM value to a standard value.
